(19) United States
(12) Patent Application Publication
(10) Pub. No.: US 2008/0267632 A1
(43) Pub. Date: Oct. 30, 2008

(54) Device for Optically Signaling an Incoming Call

(75) Inventor: Markus Neumann, Nurenberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,471

(22) PCT Filed: Mar. 31, 2005
(86) PCT No.: PCT/IB2005/051074

§ 371 Date: Sep. 29, 2006

(30) Foreign Application Priority Data
Apr. 2, 2004 (EP) 04300179.1

(51) Int. Cl. H04B 10/00

(52) U.S. Cl. 398/115

(57) ABSTRACT

The present invention relates to a device for optical signaling an incoming call in a telecommunication terminal, said terminal comprising acoustic means for signaling the incoming call with an acoustic signal and said device comprising optical means (200A, 200B) for signaling said incoming call with an optical signal, said device being characterized in that the acoustic means are coupled to the optical means such that said optical signal is dependent on parameters of the acoustic signal. For example, the optical signal can depend on the frequency of the acoustic signal or on a chronological sequence of individual tones of the acoustic signal.

### FIELD OF THE INVENTION

The present invention relates to a device for optical signaling an incoming call in a telecommunication terminal. It may be used, for example, in mobile phones.

### BACKGROUND OF THE INVENTION

Telecommunication terminals are often used in noisy environments in which the acoustic call signaling cannot be perceived indubitably. Besides, it is customary in certain environment, in order not to be a disturbing factor, to deactivate the acoustic call signaling and instead call attention to incoming calls by means of optical call signaling or a vibrator.

Known telecommunication terminals activate the display lighting and/or the keypad lighting with a constant or blinking light in case of an incoming call.

An example of such a communication terminal is disclosed in U.S. Pat. No. 6,618,601. Said patent relates to an incoming call indicator for a portable phone, in particular, it relates to an incoming call indicator for a portable phone having an antenna attached to a phone main body, projecting therefrom. The object of the patent is to provide an incoming call indicator for a portable phone with a simple configuration, having a wide light emission visible range for allowing preferable visible observation of incoming call state.

The incoming call indicator has a configuration wherein a ring-like light transmissible member is disposed between the antenna main body and the portable phone main body at the base end part of the antenna main body, and a light guiding member is provided in a hollow part of a fixing member for fixing the antenna main body, with the tip-end part of the light guiding member disposed in al hollow part of the light transmissible member as well as with a light-emitting element to be driven subject to an incoming call signal, provided facing to a light inputting part of the lower end part of the light guiding member. When an incoming call signal is detected in the portable phone, the light-emitting element is driven so as to emit a light by flickering or lighting.

### SUMMARY OF THE INVENTION

It is an object of the invention to provide an alternative to the solution of the prior art, which is more attractive to the user of a telecommunication terminal, which terminal comprises acoustic means for signaling the incoming call with an acoustic signal.

To this end, the device for optical signaling an incoming call in accordance with the invention comprises optical means for signaling said incoming call with an optical signal, and is further characterized in that the acoustic means are coupled to the optical means such that said optical signal is dependent on parameters of the acoustic signal.

Such a device allows for coupling the optical call signaling to a freely selectable acoustic signal in such a way that the user of the telecommunication terminal has an optical call signaling available which is attractive, conspicuous and individual. In other words, said device is adapted to analyze the sound sequence of the acoustic signal and to perform an optical call signaling as a function thereof.

According to an embodiment of the invention, the optical signaling device comprises a frequency-dividing network coupled to the acoustic means and adapted to deliver a control signal to the optical means such that the optical signal depends on the frequency of the acoustic signal.

According to another embodiment of the invention, the optical signaling device comprises a threshold comparator coupled to the acoustic means and adapted to deliver a control signal to the optical means such that the optical signal depends on a chronological sequence of individual tones of the acoustic signal. Said device may further comprise a dynamic detector which controls the threshold comparator in dependence on the amplitude of the individual tones of the acoustic signal.

Beneficially, the optical means comprise at least two light sources. It allows for activating said at least two light sources independently, and thus for emitting an optical signal which is more attractive to the user. The light sources may be light-emitting diodes. For example, the optical means comprise groups of light sources each group comprising a plurality of light sources connected in parallel and said groups being activated successively. The light sources may be spatially arranged in a predetermined order so as to be illuminated successively according to a running light. The optical signaling device may further comprise means for detecting a special event and means for reverting the direction of the running light in response to the detection of said special event. Said special event is, for example, a pause in the acoustic signal.

The present invention also extends to a telecommunication terminal comprising such an optical signaling device.

These and other aspects of the present invention will be apparent from, and elucidated with reference to, the embodiment described herein.

### BRIEF DESCRIPTION OF THE DRAWINGS

An embodiment of the present invention will now be described by way of example only and with reference to the accompanying drawings, in which:

FIG. 1 shows a mobile phone comprising a device for optical signaling an incoming call according to the invention;

FIG. 2 shows a block diagram of a device for optical signaling an incoming call according to a first embodiment of the invention in which the optical call signaling is adapted to the frequency of the acoustic signal;

FIG. 3 shows a block diagram of a device for optical signaling an incoming call according to another embodiment of the invention in which the optical call signaling is adapted to the chronological sequence of individual tones of the acoustic signal;

FIG. 4 shows the waveform of the signals at the inputs and outputs of the envelope detector, threshold comparator, dynamic detector and pause detector included in the device for optical signaling an incoming call of FIG. 3;

FIG. 5 shows a block diagram of an example of a luminous band according to the invention; and

FIG. 6 shows an example of a detailed electrical design of a luminous band according to the invention.

### DETAILED DESCRIPTION OF THE INVENTION

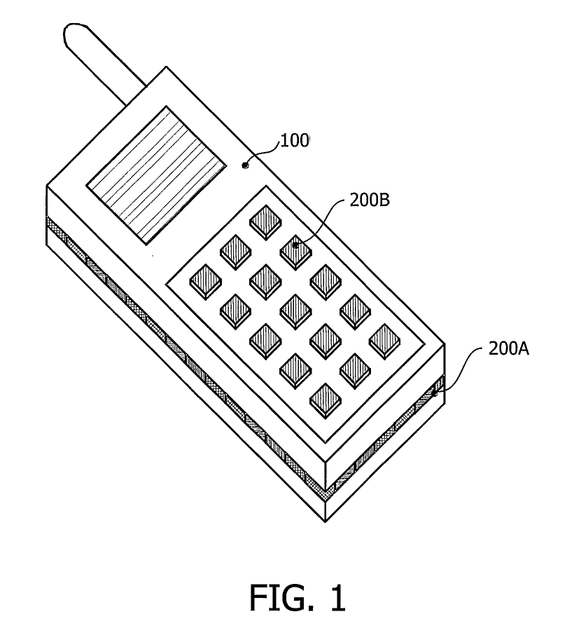

FIG. 1 shows a mobile phone 100 which has a circumferential luminous band 200A as well as a keypad 200B that can be lit. The keypad 200B has keys that can be lit individually irrespective of one another.

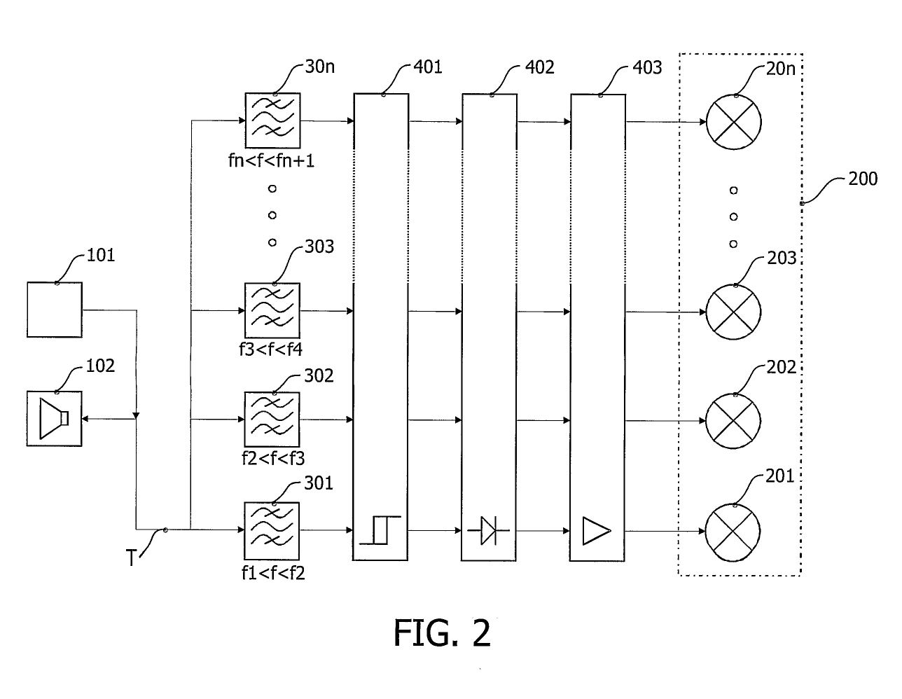

In FIG. 2 is shown a block diagram of a device for optical signaling an incoming call according to the invention in which the optical call signaling is adapted to the frequency (or pitch) of the acoustic signal, hereinafter referred as to ringing tone. In said FIG. 2, the use of the mathematical symbol n is to indicate that the number of similar chains or circuit components respectively, is not limited but can be extended to n times. The mathematical symbol n is therefore an integer greater than zero. The device for optical signaling an incoming call according to the invention comprises a ringing tone generator 101, a loud speaker 102, n band-pass filters 301 to 30n, a circuit 401 comprising n trigger comparators, a rectifying circuit 402 comprising n rectifiers, a driving circuit 403 comprising n driver stages and an optical call signaling unit 200 comprising n optical signaling circuits 201 to 20n. The mode of operation of the device for optical signaling an incoming call is the following.

A ringing tone signal T is produced by the ringing tone generator 101, which signal is transferred to a loud speaker 102 and is used here furthermore as a drive signal for the optical call signaling unit 200. For this purpose the ringing tone signal T is passed on to a frequency-dividing network, which are formed by the band-pass filters 301 to 30n. The lower limit frequency of the first band-pass filter 301 is f1 and the upper limit frequency is f2. The lower limit frequency of the second band-pass filter 302 is f2 and thus corresponds to the upper limit frequency of the first band-pass filter 301, and the upper limit frequency is f3. The system of selection of the limit frequencies of the band-pass filters 301 to 30n is continued so that the lower limit frequency of the n-th band-pass filter 30n is fn and the upper limit frequency is fn+1. In other words, the n band-pass filters have band-pass filters that are distinct and contiguous and such that f1<f2<f3< . . . <fn<fn+1.

The output signals of the band-pass filters 301 to 30n are brought to an amplitude independent of the ringing tone signal T by subsequent Schmitt trigger comparators 401, before these output signals are converted into direct voltage signals by the rectifying circuit 402. The subsequent driving circuit 403 provides the voltage and current levels necessary for operating the subsequent optical signaling circuits (or light sources) 201 to 20n. The optical signaling circuits 201 to 20n are designed, for example, as colored Light-Emitting Diodes LEDs.

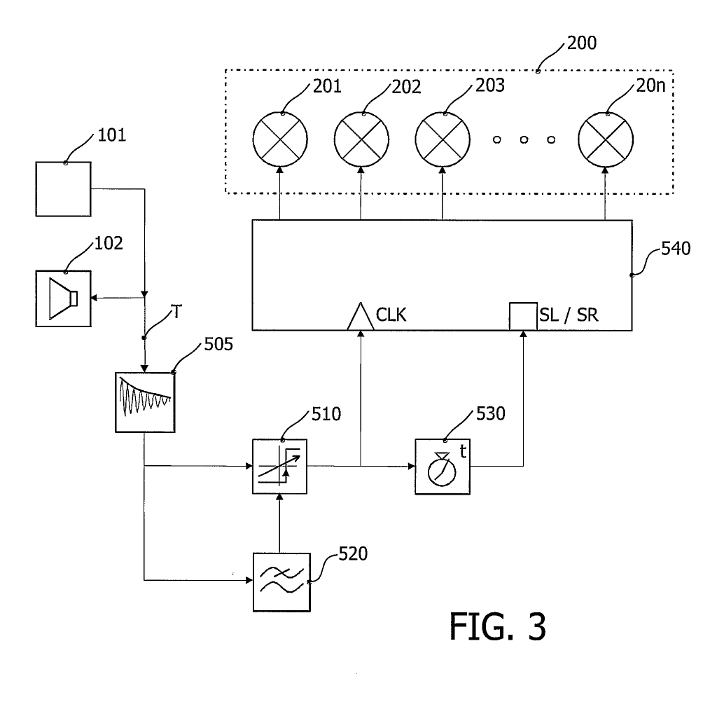

FIG. 3 shows the block diagram of a device for optical signaling an incoming call according to the invention in which the optical call signaling is adapted to the time-dependent sequence of individual tones of the ringing tone. Identical assemblies as used in FIGS. 1 and 2 have identical references and will not be again explained in the following.

The ringing tone signal T is provided first to an envelope detector 505 for detecting the amplitude of the ringing tone. The output of the envelope detector is then provided to a threshold comparator 510 which raises the signal amplitudes of the ringing tone signal T that exceed the value of the threshold comparator 510, to a maximum amplitude corresponding to the high value of a digital signal. The threshold comparator 510 is, for example, an adjustable hysteresis comparator for positive comparison values, said comparator being adapted to generate pulses when an input signal exceeds a predetermined threshold.

Furthermore, the output of the envelope detector can also be provided to a dynamic detector 520 which adapts the value of the threshold comparator 510 in dependence on the average amplitude of the ringing tone signal T. This guarantees a processing of exclusively dominant ringing tones. The dynamic detector 520 is, for example, a low pass filter. The output signal of the threshold comparator 510 is connected to the clock input CLK of a shift register 540 and serves as a clock signal for said shift register 540.

Furthermore, the output signal of the threshold comparator 510 can be applied to a signal pause detector 530 whose output is connected to the direction reversing input SL/SR of the shift register 540. This provides that, in case of longer pauses in the sound sequence of the ringing tone signal T, the shift direction of the shift register 540 is reversed, for example from shift left SL to shift right SR. The groups of optical signaling circuits 201 to 20n are connected to the output of the shift register 540 to display the running light that depends on the chronological sequence of the ringing tone.

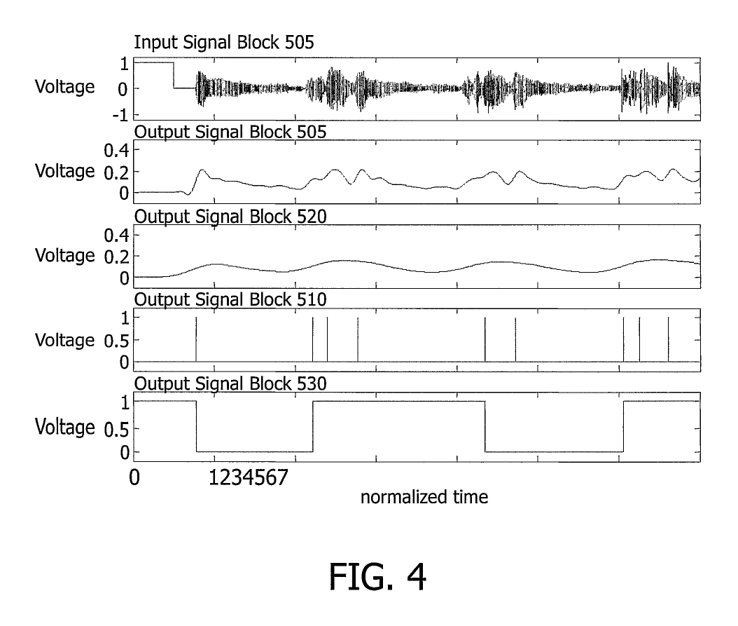

FIG. 4 shows the waveform of the signals at the inputs and outputs of the envelope detector, threshold comparator, dynamic detector and pause detector included in the device for optical signaling an incoming call of FIG. 3.

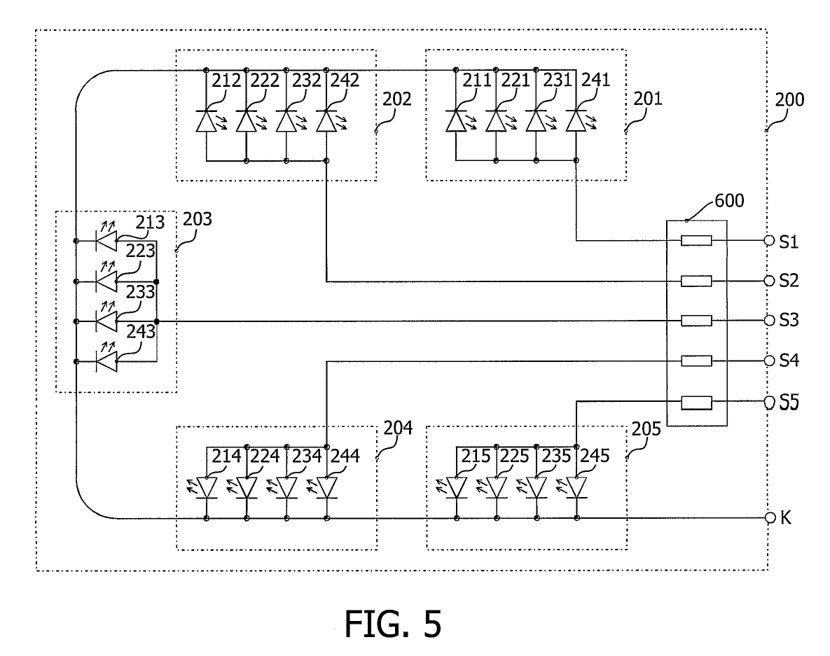

FIG. 5 shows an example of a detailed electrical design of a luminous band according to the invention. In said FIG. 5, the luminous band comprises 5 groups of light sources 201 to 205 having each 4 light sources 211-215, 221-225, 231-235 and 241-245 electrically connected in parallel. The light sources 211 to 245 are represented as LEDs. The group of light sources 201 is activated via a control input S1. Similarly, the group of light sources 202 is assigned to the control input S2. Similarly holds for the further groups of light sources 203 to 205 and the control inputs S3 to S5. A resistor array 600 is connected between the control inputs S1 to S5 and the groups of light sources 201 to 205 and is used for limiting the current in the light sources 211 to 245. All light sources 211 to 245 integrated into the luminous band have a common cathode terminal K.

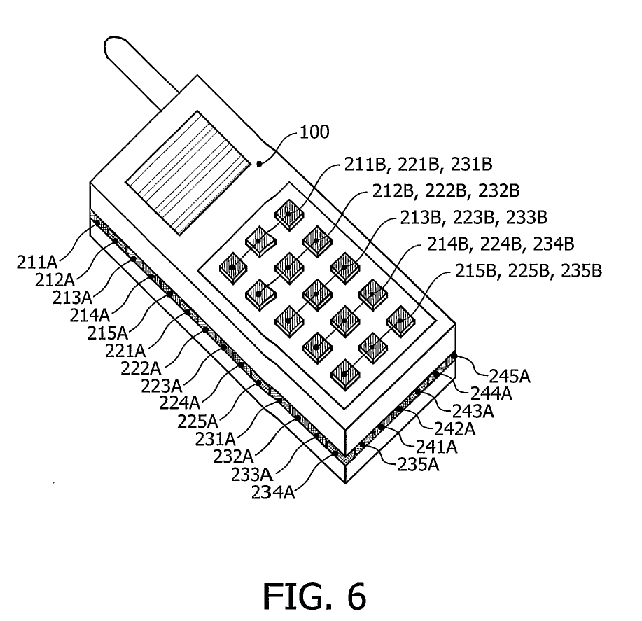

FIG. 6 shows a mechanical arrangement of light sources as shown in FIG. 5 in a mobile phone. The drive circuit is, for example, an arrangement shown in FIG. 3 in which the optical call signaling is adapted to the time-dependent sequence of individual tones of the ringing tone.

The index A is to indicate that the light sources 211A to 245A form part of a luminous band. The mechanical arrangement is such that it causes each group of four light sources, for example 211A-221A-231A-241A, to light up simultaneously and at the next beat of the ringing tone signal T an adjacent group of light sources 212A-222A-232A-242A in the direction of rotation, to take over the lighting function. This can produce the effect of a running light.

Index B is to indicate that the light sources 211B to 235B form part of the keypad lighting. The arrangement according to this example causes the running light to be realized by the keypad lighting up in a row-by-row manner.

Several embodiments of the present invention have been described above by way of examples only, and it will be apparent to a person skilled in the art that modifications and variations can be made to the described embodiments without departing from the scope of the invention as defined by the appended claims. For example, the optical call signaling can be dependent on the value of the amplitude of the acoustic signal. As another example, the key of the keypad can be illuminated individually.

Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A device for optical signaling an incoming call in a telecommunication terminal, said terminal comprising acoustic means (101,102) for signaling the incoming call with an acoustic signal and said device comprising optical means (200) for signaling said incoming call with an optical signal, said device being characterized in that the acoustic means are coupled to the optical means such that said optical signal is dependent on parameters of the acoustic signal.

2. A device as claimed in claim 1, further comprising a frequency-dividing network (301-30n) coupled to the acoustic means and adapted to deliver a control signal to the optical means such that the optical signal depends on the frequency of the acoustic signal.

3. A device as claimed in claim 1, further comprising a threshold comparator (510,540) coupled to the acoustic means and adapted to deliver a control signal to the optical means such that the optical signal depends on a chronological sequence of individual tones of the acoustic signal.

4. A device as claimed in claim 3, further comprising a dynamic detector (520), which controls the threshold comparator (510) in dependence on the amplitude of the individual tones of the acoustic signal.

5. A device as claimed in claim 1, wherein the optical means comprise at least two light sources.

6. A device as claimed in claim 5, wherein the light sources are light-emitting diodes.

7. A device as claimed in claim 5, wherein the optical means comprise groups (201-205) of light sources, each group (201) comprising a plurality of light sources (211,221,231,241) connected in parallel and said groups being activated successively.

8. A device as claimed in claim 7, wherein said light sources are spatially arranged in a predetermined order so as to be illuminated successively according to a running light.

9. A device as claimed in claim 8, further comprising means (530) for detecting a special event and means (540) for reverting the direction of the running light in response to the detection of said special event.

10. A telecommunication terminal comprising acoustic means (101,102) for signaling an incoming call with an acoustic signal and optical means (200) for signaling said incoming call with an optical signal, said terminal being characterized in that the acoustic means are coupled to the optical means such that said optical signal is dependent on parameters of the acoustic signal.
